(19) United States
(12) Patent Application Publication
(10) Pub. No.: US 2007/0240455 A1
(43) Pub. Date: Oct. 18, 2007

(54) Optical fiber preform fabricating apparatus

(75) Inventors: Gu-Young Kang, Gumi-si (KR); Yeong-Seop Lee, Gumi-si (KR); Jin-Han Kim, Gumi-si (KR)

Correspondence Address: CHA & REITER, LLC, 210 ROUTE 4 EAST STE 103, PARAMUS, NJ, 07652, US

(73) Assignee: Samsung Electronics Co,; LTD

(21) Appl. No.: 11/204,661

(22) Filed: Aug. 16, 2005

(30) Foreign Application Priority Data
Nov. 24, 2004 (KR) 2004-96759

(51) Int. Cl. C03C 25/10

(52) U.S. Cl. 65/529

(57) ABSTRACT

An optical fiber preform fabricating apparatus capable of simultaneously mounting and fabricating a plurality of preforms and adaptable according to the length of performs is provided. The apparatus heats a plurality of quartz tubes using at least one burner to deposit chemical reactants on the outer walls of the quartz tubes. To this end, the apparatus includes a chamber housing extending longitudinally and a variable-length structure mounted within the chamber housing in a longitudinal direction, wherein the variable-length structure is adjustable in accordance with the length of the quartz tubes and horizontally moves back and forth in the longitudinal direction.

### CLAIM OF PRIORITY

This application claims priority to an application entitled “Optical Fiber Preform Fabricating Apparatus,” filed with the Korean Intellectual Property Office on Nov. 24, 2004 and assigned Serial No. 2004-96759, the contents of which are hereby incorporated by reference.

### BACKGROUND OF THE INVENTION

1. Field of the Invention

The present invention relates to an optical fiber preform fabricating apparatus that is capable of simultaneously mounting and fabricating a plurality of preforms and adapting to different lengths of preforms.

2. Description of the Related Art

An optical communication medium using light over an optical fiber can transmit larger volumes of information than a coaxial cables transmission medium can.

In general, the fabrication of optical fibers involves a production of an optical fiber preform. There are several methods of preparing preforms which include outside vapor deposition (OVD), vapor-phase axial deposition (VAD) and modified chemical vapor deposition (MCVD). In the OVD, a rotating target rod (an alumina mandrel) is heated using a burner, which burner feeds chemicals to be deposited on the outside of the target rod by thermophoresis. The OVD method is characterized by the layer-by-layer deposition of chemicals to form a core layer on the outside of the target rod and a cladding layer on the core layer. The MCVD differs from the OVD in that the deposition occurs inside a quartz tube instead of on the outside. While the quartz tube is being heated by a burner, chemicals are fed into the tube to form a cladding layer on the internal wall of the tube and then a core layer inside the internal wall of the cladding layer is formed by thermophoresis. In the VAD, two different burners (an upper burner and a lower burner) are used to simultaneously deposit a core layer and a cladding layer on a target rod in the upright position.

FIG. 1 shows an apparatus used to perform the OVD process. Briefly, in a chamber 1 and a hood 2, a pair of chucks 3 is provided on a horizontal lathe to face each other and support a quartz tube 4 in such a manner that the quartz tube 4 can rotate about its longitudinal axis. Also, a burner 6 movable along a rail 5 is provided below the quartz tube 4. While moving along the rail 5, the burner 6 traverses back and forth along the length of the rotating quartz tube 4 to heat the tube 4. SiCl and other chemical reactants 100 entrained in oxygen gas are fed in the form of a gaseous mixture into the quartz tube 4 to form soot particles that will be deposited on the quartz tube 4.

Various approaches have been suggested to improve productivity in the MCVD process. In the OVD process, a large-size preform fabricating apparatus has been developed to fabricate multiple and larger performs. Accordingly, it is possible to fabricate larger sized preforms to a certain extent using the initially designed apparatus, without the need for enlarging or reforming the apparatus. Fabricating longer performs increases the cost for production facility. In addition, the linear reciprocating rail generally has a complicated burner structure. Changes in the burner structure and the gas lines may cause serious problems in achieving a uniform flow of gas which results in vortex of gas flow and deteriorates the quality of the resulting preform. Further, the rail placed at a relatively lower temperature area may improperly operate due to condensation of corrosive gas and load of undeposited soot particles. Ultimately, the corrosion frequently leads to reduced durability in the preform fabricating apparatus.

### SUMMARY OF THE INVENTION

Accordingly, the present invention has been made to solve the above-mentioned problems occurring in the prior art and provides additional advantages, by providing an optical fiber preform fabricating apparatus that is capable of simultaneously mounting and fabricating a plurality of preforms and adapting to different lengths of preform.

One aspect of the present invention is to provide an optical fiber preform fabricating apparatus having means for a horizontal reciprocating motion of a plurality of preforms at the upper part thereof, thereby preventing corrosion due to the drop of undeposited soot and chemical reactants and enhancing durability.

Another aspect of the present invention is to provide an optical fiber preform fabricating apparatus capable of discharging undeposited soot and chemical reactants entrained in oxygen gas in the form of a gaseous mixture, thereby preventing the generation of vortex and providing uniform and stable deposition conditions.

Still another aspect of the present invention is to provide an optical fiber preform fabricating apparatus for heating a plurality of quartz tubes using at least one burner to deposit chemical reactants on the outer walls of the quartz tubes, which comprises: a chamber housing extending longitudinally and having a plurality of hoods on top thereof; a pair of moving means provided within the housing in a longitudinal direction; first and second stocks mounted on the moving means in a plane perpendicular to the longitudinal direction to rotatably hold the plurality of quartz tubes and perform a horizontal reciprocating motion in the longitudinal direction; a pair of bed module arrays, each comprising at least one module and mounted between the first and second stocks to be extendable in the longitudinal direction to adjust the distance between the first and second stocks in accordance with the length of the quartz tubes; and a power transfer means for transferring power to make the first and second stocks horizontally move back and forth.

### BRIEF DESCRIPTION OF THE DRAWINGS

The above features and advantages of the present invention will be more apparent from the following detailed description taken in conjunction with the accompanying drawings, in which:

FIG. 1 is a schematic view of a conventional optical fiber preform fabricating apparatus using outside vapor deposition (OVD);

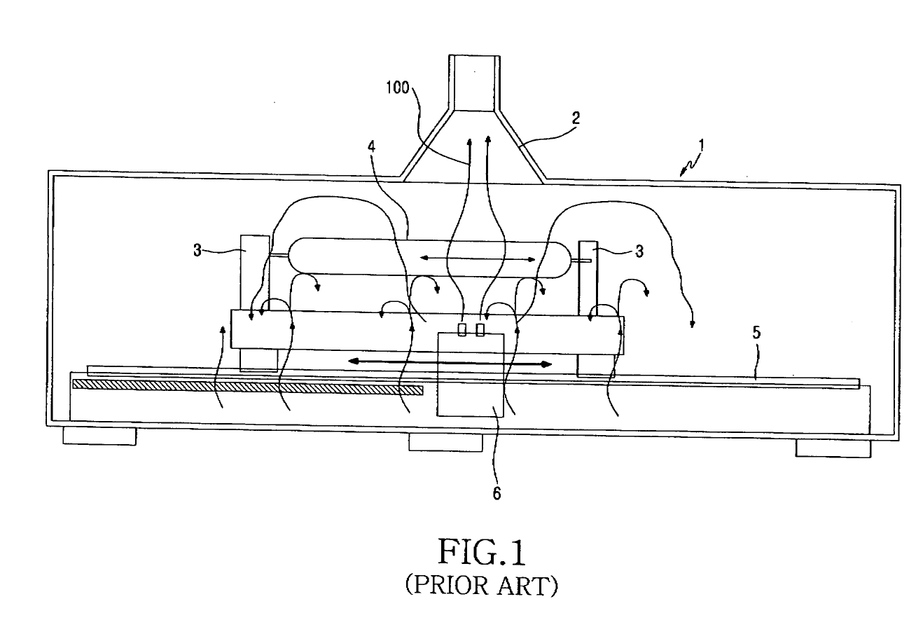

FIG. 2 is a front cut-away view of the structure of an optical fiber preform fabricating apparatus according to the present invention;

FIG. 3 is an enlarged front view of part A in FIG. 2;

FIG. 4 is a cross-sectional side view of an optical fiber preform fabricating apparatus according to the present invention;

FIG. 5 is a perspective view of an optical fiber preform fabricating apparatus according to the present invention;

FIG. 6 is an enlarged perspective view of part B in FIG. 5;

FIG. 7 is an enlarged perspective view of part C in FIG. 5;

FIG. 8 is an enlarged perspective view of part D in FIG. 5;

FIG. 9 is an enlarged perspective view of part E in FIG. 5;

FIG. 10 is a perspective view of the assembled state of an optical fiber preform fabricating apparatus according to the present invention;

FIG. 11 is a perspective view of the operational state of an optical fiber preform fabricating apparatus according to the present invention;

FIG. 12 is a side view of the operational state of an optical fiber preform fabricating apparatus according to the present invention;

FIG. 13 is an enlarged perspective view of part F in FIG. 12; and

FIG. 14 is a cross-sectional view showing the mounting of a permanent magnet of an optical fiber preform fabricating apparatus according to the present invention.

### DETAILED DESCRIPTION

Hereinafter, an embodiment of the present invention will be described with reference to the accompanying drawings. For the purposes of clarity and simplicity, a detailed description of known functions and configurations incorporated herein will be omitted as it may make the subject matter of the present invention unclear.

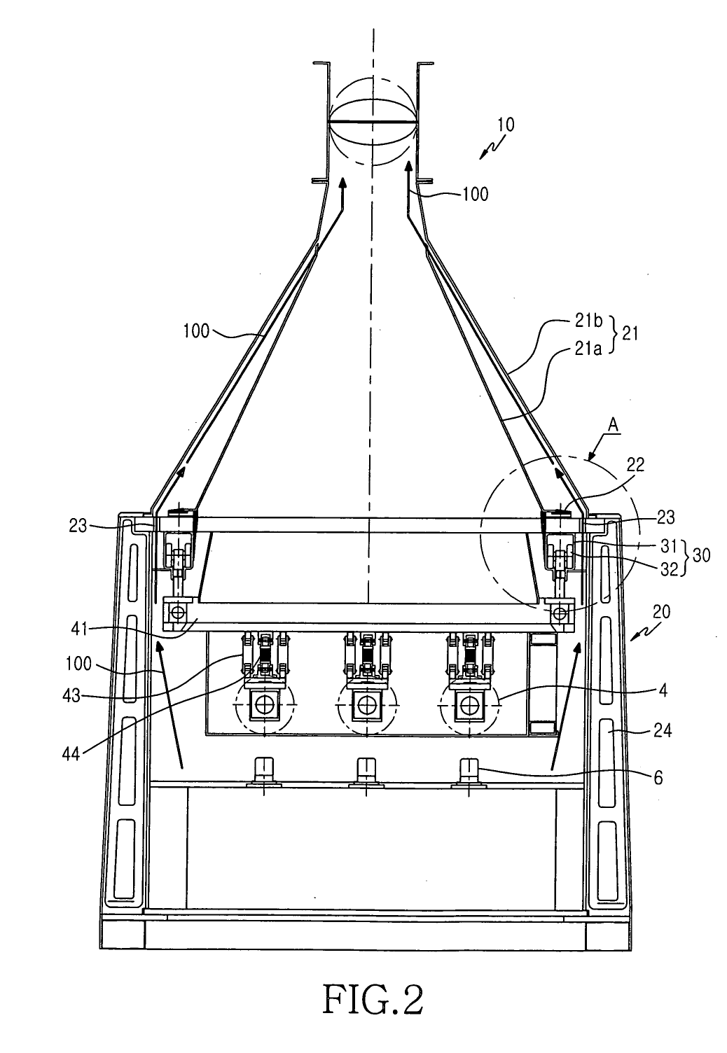

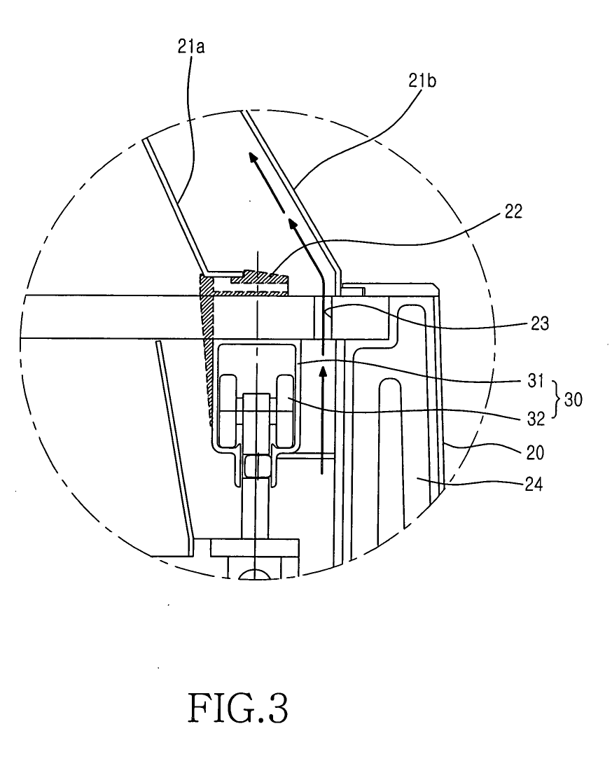

Referring to FIG. 2, an optical fiber preform fabricating apparatus 10 according to the present invention includes a chamber housing 20, a pair of moving means 30, first and second stocks 40 and 50, a pair of bed module arrays 60, and a power transfer means 70. As shown in FIGS. 2 and 3, a plurality of hoods 21 is provided on top of the chamber housing 20 to discharge undeposited soot 100 and chemical reactants entrained in oxygen gas in the form of a gaseous mixture 100.

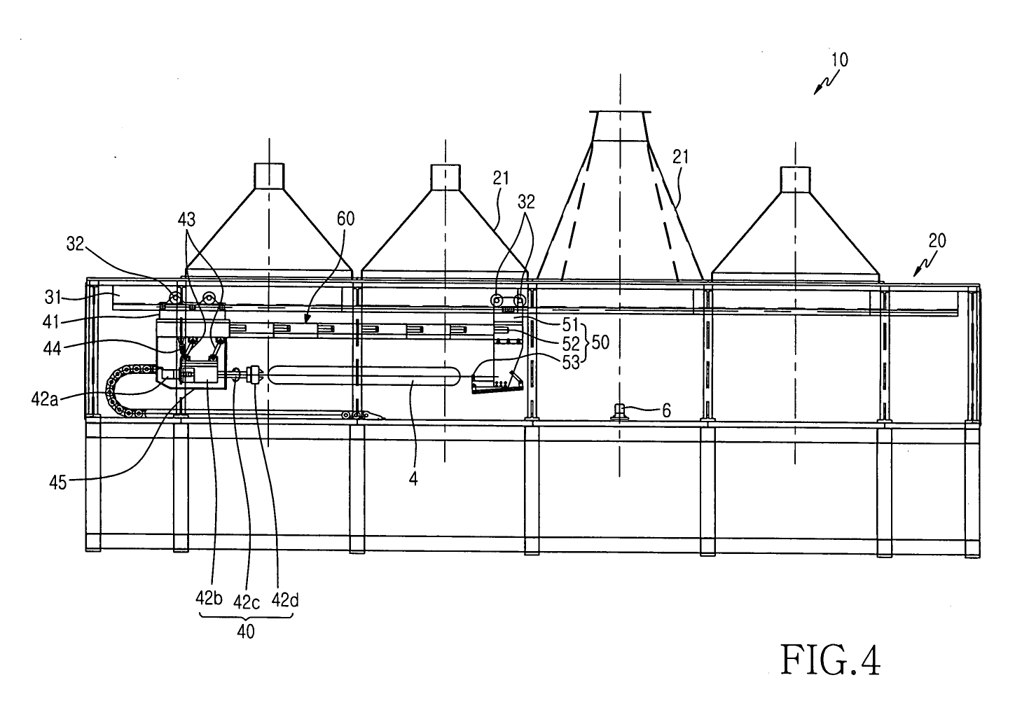

Referring to FIG. 4, the pair of moving means 30 is provided within the chamber housing 20 in a longitudinal direction for enabling a horizontal reciprocating motion of the first and second stocks 40 and 50 in the same longitudinal direction.

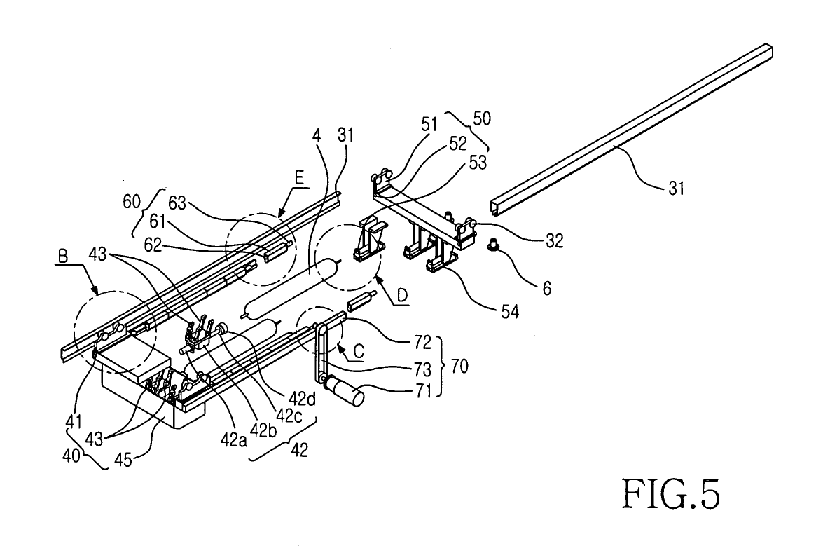

Referring to FIG. 5, the first and second stocks 40 and 50 are mounted on the moving means 30 in a plane perpendicular to the longitudinal direction in order to rotatably hold a plurality of quartz tubes and perform a horizontal reciprocating motion in the longitudinal direction. The bed module arrays 60 mounted between the first and second stocks 40 and 50 are extendable in the longitudinal direction to adjust the distance between the first and second stocks in accordance with the length L1 of the quartz tubes. The power transfer means 70 provided on the lateral side within the chamber housing 20 transfers power to make the first and second stocks 40 and 50 horizontally move back and forth.

Referring to FIGS. 2 and 3, the hood 21 on top of the chamber housing 20 includes an inner hood 21a and an outer hood 21b to discharge undeposited soot 100 and chemical reactants entrained in oxygen gas in the form of a gaseous mixture 100. A pair of hood adapters 22 provided at both top ends of the chamber housing 20 is used to connect and fix the hood 21 to the chamber housing 20. Gas outlets 23 formed adjacent to the hood adapters 22 discharge the gaseous mixture 100 of undeposited soot and chemical reactants entrained in oxygen gas through the hood 21. In addition, at least one support rib 24 for supporting the chamber housing 20 is provided at both sides of the chamber housing 20.

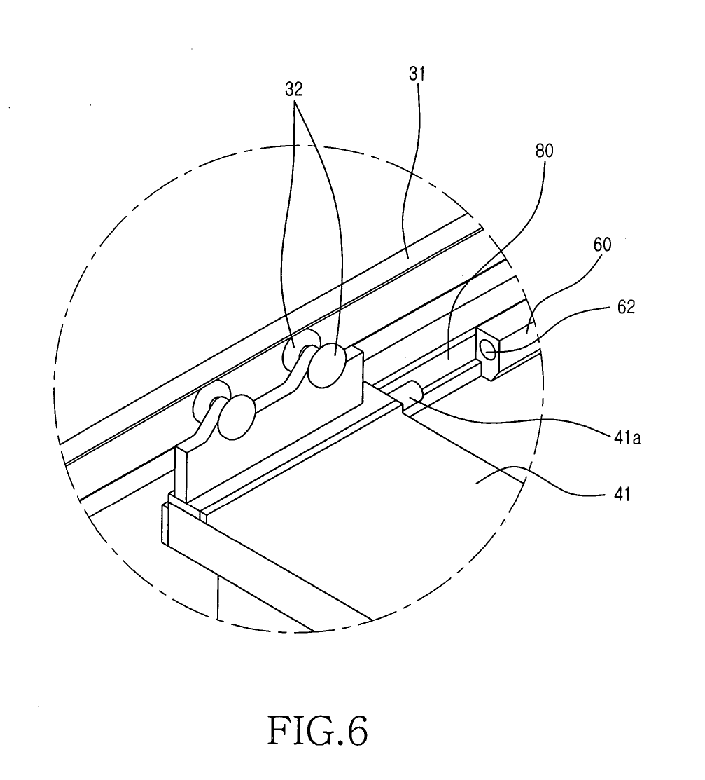

Referring to FIGS. 5 and 6, the moving means 30 consists of a pair of moving rails 31 and at least one roller 32. The moving rails 31 are mounted on the inner wall of the upper part of the chamber housing 20 in a longitudinal direction. The roller 32 is mounted in the moving rails 31 to be horizontally movable in the longitudinal direction along the moving rails 31.

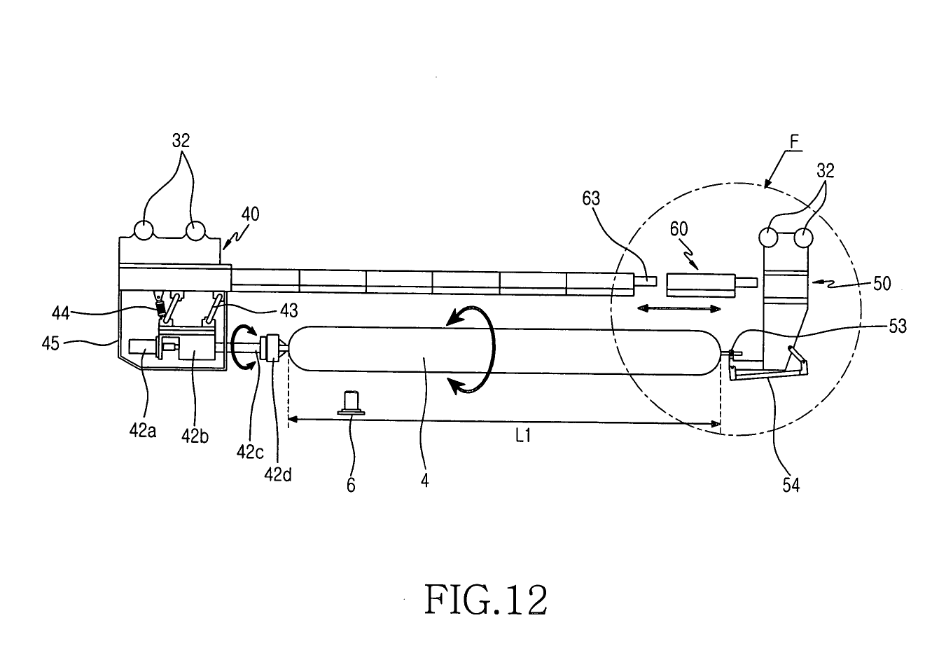

Referring to FIGS. 5 and 12, the first stock 40, which comprises a head stock, has a housing 45 containing at least one rotating means 42 and at least one link 43. The housing 45 is connected to the roller 32 by means of a head connection member 41 provided on top thereof. The rotating means 42 for rotating the quartz tube 4 is received in the housing 45 under the head connection member 41. The link 43 in the housing 45 fixes the rotating means 42 to the head connection member 41.

Referring to FIG. 6, the head connection member 41 has a projection 41a formed in the longitudinal direction of the chamber housing 20 to be fitted into a recess 62 formed on a bed module of the bed module array 60.

Referring to FIG. 12, the rotating means 42 consists of a rotating motor 42a, a reduction module 42b, a rotating shaft 42c, and a rotating chuck 42d. The rotating shaft 42c is connected to the reduction module 42b to transfer a turning force generated from the rotating motor 42a to the rotating chuck 42d. The rotating chuck 42d provided at one end of the rotating shaft 42c serves to hold one end of a quartz tube 4 and rotates with the rotation of the rotating shaft 42c.

The link 43 has one end connected to the bottom surface of the head connection member 41 and the other end connected to the top surface of the reduction module 42b, thereby connecting the reduction module 42b to the head connection member 41.

Referring to FIG. 12, a load cell 44 is provided between the head connection member 41 and the reduction module 42b to measure in real time the weight of the quartz tube 4 which changes with the deposition of chemical reactants during the rotation of the quartz tube 4.

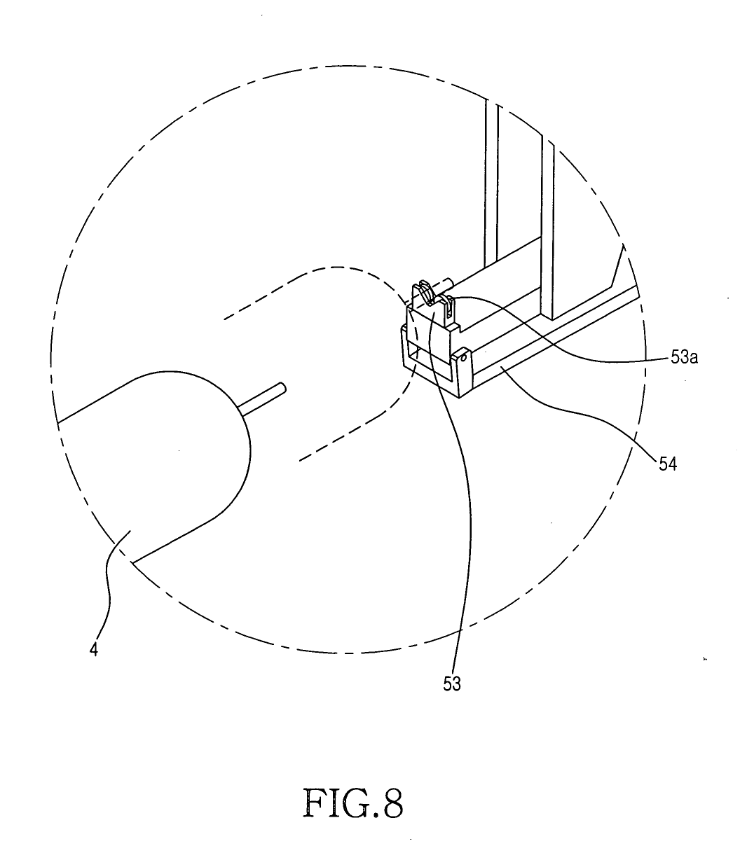

Referring to FIGS. 5 and 8, the second stock 50 comprising at least one tail stock 50 has a tail connection member 51 to be connected to the roller 32. The tail stock 50 has a recess 52 into which a projection 63 of the last bed module of the bed module array 60 can be inserted. Thus, it is possible to interlock as many bed modules as needed to adjust the distance between the head stock 40 and the tail stock 50 in accordance with the length L1 of the quartz tube 4. Also, at least one tail chuck 53 is provided at the lower part of the tail stock 50 at the position opposite to the rotating chuck 42d. The tail chuck 53 is rotatably connected to the other end of the quartz tube 4.

Referring to FIG. 8, the tail chuck 53 has a V block in which a pair of bearings 53a is provided to enable the quartz tube 4 to rotate therebetween.

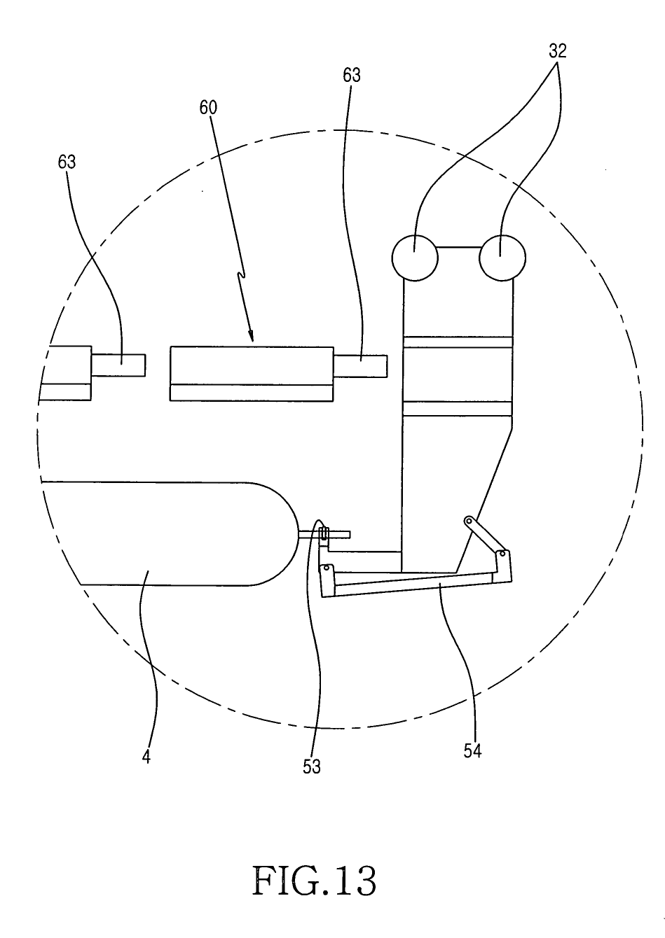

Referring to FIG. 13, the tail stock 50 has a support bracket 54 for supporting the tail chuck 53.

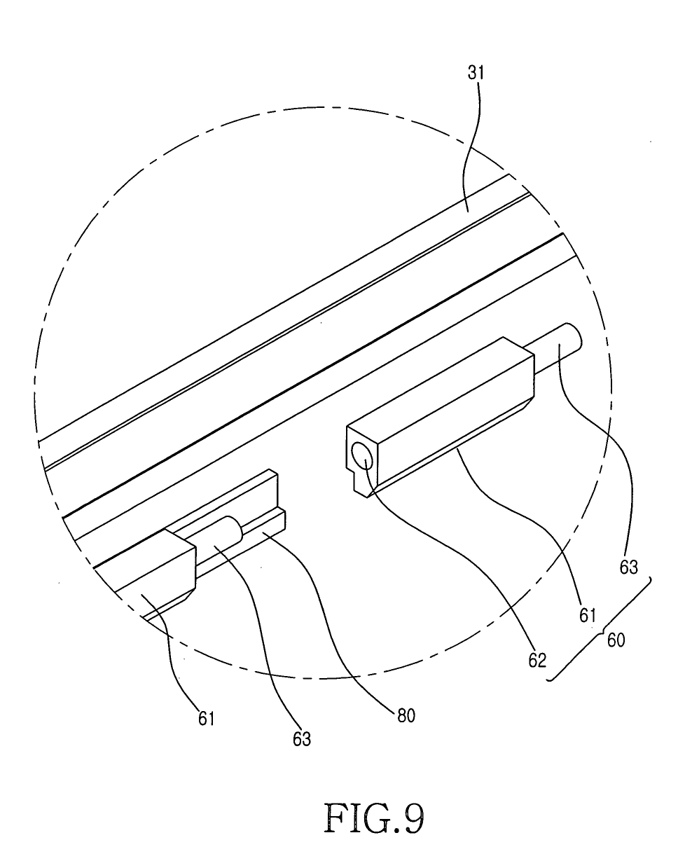

Referring to FIG. 9, each bed module of bed module array 60 consists of a body 61, a recess 62 formed on one end of the body 61, and a projection 63 formed on the other end of the body 61. The overall length of the bed module arrays 60 can be increased by interlocking additional bed modules in such a manner that the projection 63 of one bed module is fitted into the recess 62 of another, thereby adjusting the distance between the head stock 40 and the tail stock 50 in accordance with the length L1 of the quartz tube 4.

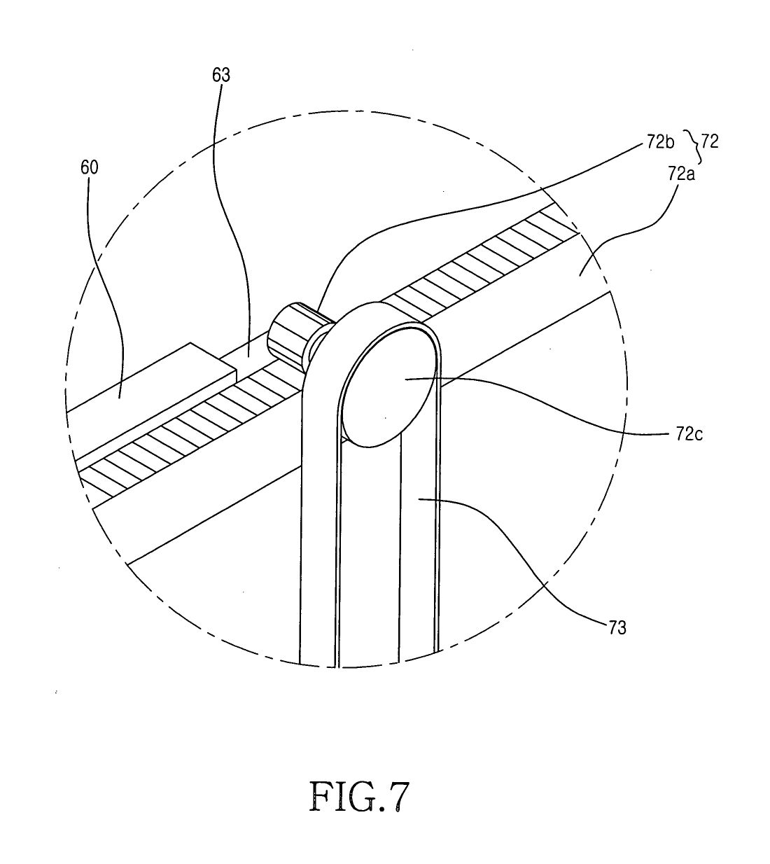

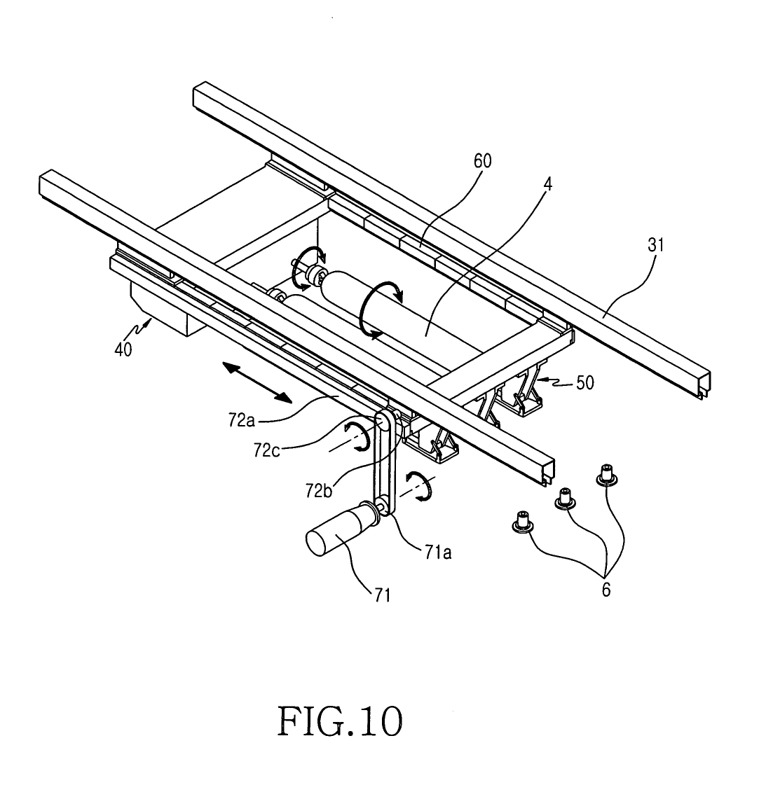

Referring to FIGS. 7 and 10, the power transfer means 70 includes a driving motor 71, a gear 72, and a power transfer belt 73. The driving motor 71 is provided at one side of the chamber housing 20 to transfer a driving force to the gear 72. The gear 72 provided along the length of one bed module array 60 converts a rotary motion from the motor 71 into a horizontal reciprocating motion. The power transfer belt 73 is held securely in place over a belt pulley 71 a of the driving motor 71 and a belt pulley 72c of the gear 72.

Referring to FIG. 7, the gear 72 consists of a rack gear 72a and a pinion gear 72b. When the pinion gear 72b rotates with the rotation of the driving motor 71, the rack gear 72a connected to the outer lateral side of the bed module array 60 horizontally moves the bed module array 60 back and forth in the longitudinal direction. When the pinion gear 72b in mesh with the rack gear 72a turns with the rotation of the driving motor 71, it causes the rack gear 72a to linearly move back and forth.

Referring to FIG. 9, the two bed module arrays 60 are provided at both inner sides of the chamber housing 20 in the longitudinal direction. The bed module array 60 at one side is coupled to the gear 72, while the bed module array 60 at the other side is coupled to a guide rib 80 that guides the horizontal reciprocating motion of the bed module array 60.

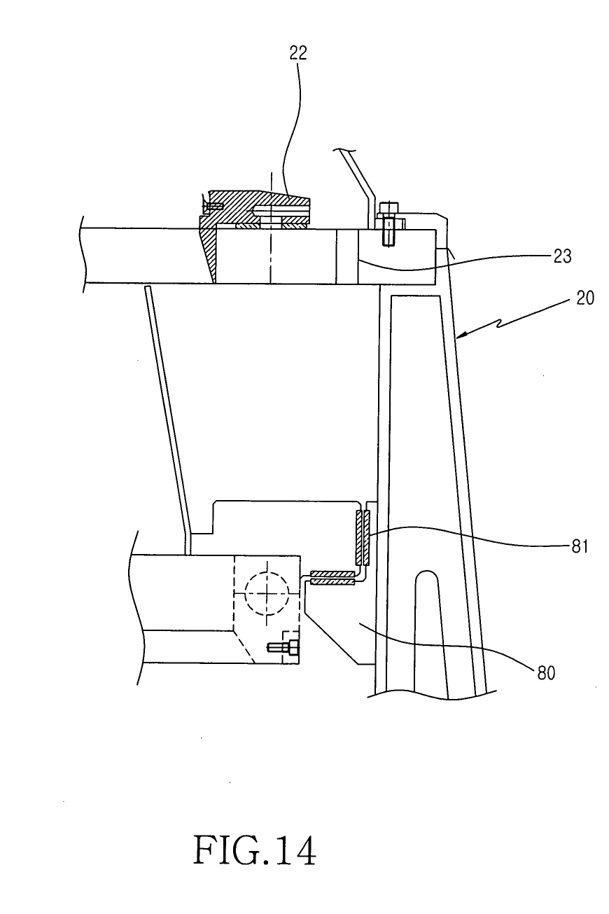

Referring to FIG. 14, at least one permanent magnet 81 is provided within the guide rib 80 to guide a horizontal reciprocating motion of the bed module array 60 using a repulsive force of the magnet 81.

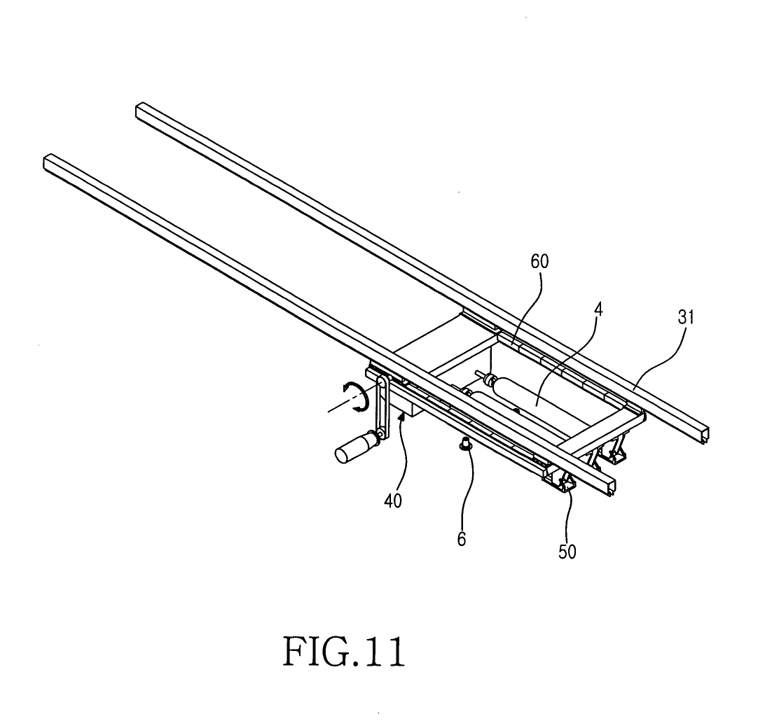

Referring to FIGS. 10 and 11, at least one burner 6 is placed below the quartz tube 4 in a plane perpendicular to the length of the chamber housing 20.

Hereinafter, the operation of the optical fiber preform fabricating apparatus according to the present invention will be explained in detail with reference to FIGS. 2 through 14.

When at least one quartz tube 4 is mounted within the longitudinally extending chamber housing 20 as shown in FIGS. 2 and 3, the distance between at least one head stock 40 and at least one tail stock 50 is adjusted in accordance with the length L1 of the quartz tube 4.

Referring to FIG. 12, the bed module arrays 60 and the tail stock 50 can be separated from each other by pulling out the projection 63 of the last bed module 60 from the recess 52 formed on the tail stock 50.

The separated tail stock 50 can be moved along the rails 31 provided on the inner wall of the chamber housing 20.

Since the tail connection member 51 formed on top of the tail stock 50 is connected to the roller 32, the tail stock 50 is guided by the roller 32 mounted on the moving rails 31.

Referring to FIG. 9, each bed module of the separated bed module arrays 60 has a projection 63 and a recess 62.

The overall length of the bed module arrays 60 can be adjusted in accordance with the length L1 of the quartz tube 4. When the length L1 of the quartz tube 4 is increased, the overall length of the bed module arrays 60 can also be increased by interlocking additional bed modules in such a manner to fit the projection 63 of one bed module into the recess 62 of another.

The projection 63 of the last bed module 60 is then fitted into the recess 52 formed on the tail stock 50.

Referring to FIGS. 4 and 5, the tail stock 50 faces the head stock 40. Both ends of the quartz tube 4 are held respectively by the rotating chuck 42d of the head stock 40 and the counterpart chuck 53 of the tail stock 50.

Under this condition, as shown in FIGS. 10 and 11, the quartz tube 4 horizontally moves back and forth along the moving rails 31 provided in the longitudinal direction of the chamber housing 20.

Referring to FIG. 12, at least one burner 6 provided below the quartz tube 4 heats the tube 4.

Referring to FIGS. 7 and 11, the rack gear 72a provided along the lateral side of one bed module array 60 in the longitudinal direction changes the rotary motion from the driving motor 71 into a linear reciprocating motion. When the driving force generated from the driving motor 71 rotates the pinion gear 72b, the rack gear 72a in mesh with the pinion gear 72b horizontally moves in the longitudinal direction.

With the horizontal movement of the rack gear 72a, the head stock 40 and the tail stock 50 also move and cause the quartz tube 4 to move simultaneously.

The other bed module array 60 is coupled to the guide rib 80 that guides the horizontal reciprocating motion of the head stock 40, tail stock 50, and the quartz tube 4.

Referring to FIG. 14, at least one permanent magnet 81 is provided within the guide rib 80 to guide the horizontal reciprocating motion using a repulsive force of the magnet 81.

Referring to FIG. 12, the head connection member 41 connected to the roller 32 is provided on top of the head stock 40. Also, at least one rotating means 42 for rotating the quartz tube 4 is provided under the head connection member 41.

The rotating means 42 includes the rotating chuck 42d that holds one end of the quartz tube 4. The rotating chuck 42d is connected to the rotating shaft 42c which is connected to the rotating motor 42a.

When the rotating motor 42a operates and generates a turning force, the rotating shaft 42c transfers the turning force to the rotating chuck 42d.

The burner 6 heats the rotating quartz tube 4 and deposits chemicals on the quartz tube 4 to produce an optical fiber preform.

With the deposition of chemical reactants, the quartz tube 4 becomes heavier. As shown in FIG. 12, the load cell 44 provided in the head stock 40 measures the weight of the quartz tube 4 in realtime. The measured weight can tell the progress of the fabrication of the optical fiber preform from the quartz tube 4.

Referring back to FIGS. 2 and 3, a pair of hood adapters 22 is provided at both top ends of the chamber housing 20 to connect and fix the hood 21 consisting of the inner hood 21a and the outer hood 21b to the top of the chamber housing 20.

Referring back to FIG. 3, the gas outlets 23 formed adjacent to the hood adapters 22 discharge undeposited soot 100 and a gaseous mixture 100 of chemical reactants entrained in oxygen gas through the hood 21. Undeposited soot 100 and gas 100 remaining at the bottom of the chamber housing 20 pass through the gas outlets 23 and enter the inner hood 21a and the outer hood 21b to be discharged.

As explained above, the length of the bed module arrays and the distance between the head stock and the tail stock can be adjusted in accordance with the length of the quartz tube when fabricating a preform. Accordingly, it is possible to fabricate preforms of various sizes without the need for enlarging or reforming the optical fiber preform fabricating apparatus which in turn saves any additional expenses in the production facility and reduces the manufacturing cost. In addition, the gas outlets provided on the chamber housing rapidly discharge undeposited soot and chemical reactants, thereby preventing corrosion and enhancing the durability of the preform fabricating apparatus.

Although an embodiment of the present invention has been described for illustrative purposes, those skilled in the art will appreciate that various modifications, additions and substitutions are possible, without departing from the scope and spirit of the invention as disclosed in the accompanying claims, including the full scope of the equivalents thereof.

What is claimed is:

1. An optical fiber preform fabricating apparatus for heating a plurality of quartz tubes using at least one burner to deposit chemical reactants on the outer walls of the quartz tubes, comprising:
a chamber housing extending longitudinally and having a plurality of hoods on top thereof;
a pair of moving means provided within the housing in a longitudinal direction;
first and second stocks mounted on the moving means in a plane perpendicular to the longitudinal direction to rotatably hold the plurality of quartz tubes and to perform a horizontal reciprocating motion in the longitudinal direction;
a pair of bed module arrays, each comprising at least one module and mounted between the first and second stocks to be extendable in the longitudinal direction to adjust the distance between the first and second stocks in accordance with the length of the quartz tubes; and
a power transfer means for transferring power to make the first and second stocks move horizontally back and forth.

2. The optical fiber preform fabricating apparatus as claimed in claim 1, wherein the hoods of the chamber housing consist of an inner hood and an outer hood and are coupled to the chamber housing by means of a pair of hood adapters provided at both top ends of the chamber housing.

3. The optical fiber preform fabricating apparatus as claimed in claim 2, wherein the chamber housing further includes gas outlets formed adjacent to the hood adapters to discharge undeposited soot and chemical reactants entrained in oxygen gas in form of a gaseous mixture through the hoods.

4. The optical fiber preform fabricating apparatus as claimed in claim 1, further comprising at least one support rib provided at both sides of the chamber housing to support the chamber housing.

5. The optical fiber preform fabricating apparatus as claimed in claim 1, wherein the pair of moving means includes:
a pair of moving rails mounted on the inner wall at the upper part of the chamber housing in the longitudinal direction; and
at least one roller mounted in the moving rails to be horizontally movable in the longitudinal direction along the moving rails.

6. The optical fiber preform fabricating apparatus as claimed in claim 1, wherein the first stock comprises at least one head stock which includes:
a housing and a head connection member on top of the housing;
at least one rotating means provided below the head connection member to rotate the quartz tube; and
at least one link for fixing the rotating means to the head connection member.

7. The optical fiber preform fabricating apparatus as claimed in claim 6, wherein the head connection member has a projection formed in the longitudinal direction of the chamber housing to be fitted into a recess formed on a bed module of the bed module arrays.

8. The optical fiber preform fabricating apparatus as claimed in claim 6, wherein said rotating means includes:
a rotating motor with a reduction module;
a rotating shaft coupled to the rotating motor to be rotatable by a turning force generated from the rotating motor; and
a rotating chuck provided at one end of the rotating shaft to hold one end of the quartz tubes and to rotate with the rotation of the rotating shaft.

9. The optical fiber preform fabricating apparatus as claimed in claim 6, wherein the link has one end coupled to the bottom surface of the head connection member and the other end coupled to the top surface of the reduction module.

10. The optical fiber preform fabricating apparatus as claimed in claim 6, wherein a load cell is provided between the head connection member and the reduction module to measure the weight of the quartz tube in real time during the rotation of the quartz tube.

11. The optical fiber preform fabricating apparatus as claimed in claim 1, wherein the second stock comprises at least one tail stock and includes:
a tail connection member provided on top of the tail stock and coupled to the roller;
a recess into which a projection of a bed module of the bed module arrays can be inserted; and
at least one tail chuck provided at the lower part of the tail stock at a position opposite to the rotating chuck and rotatably coupled to the other end of the quartz tube.

12. The optical fiber preform fabricating apparatus as claimed in claim 11, wherein the tail chuck has a V block in which a pair of bearings is provided to enable the quartz tube to rotate therebetween.

13. The optical fiber preform fabricating apparatus as claimed in claim 11, wherein the tail stock has at least one support bracket for supporting the tail chuck.

14. The optical fiber preform fabricating apparatus as claimed in claim 1, wherein each bed module of each bed module array includes:
a body extendable longitudinally;
a recess formed on one end of the body; and
a projection formed on the other end of the body and insertable into a recess of another bed module, thereby increasing the overall length of the bed module array.

15. The optical fiber preform fabricating apparatus as claimed in claim 1, wherein the power transfer means includes:
a driving motor provided at one side of the chamber housing;
a gear provided along the length of one bed module array to convert a rotary motion from the driving motor into a horizontal reciprocating motion; and
a power transfer belt held securely in place over a belt pulley of the driving motor and a belt pulley of the gear.

16. The optical fiber preform fabricating apparatus as claimed in claim 15, wherein the gear includes:
a rack gear connected to the outer lateral side of the bed module array in the longitudinal direction; and
a pinion gear in mesh with the rack gear.

17. The optical fiber preform fabricating apparatus as claimed in claim 1, wherein the bed module arrays are provided at both inner sides of the chamber housing in the longitudinal direction, one bed module array being coupled to the gear and the other being coupled to a guide rib that guides the horizontal reciprocating motion of the other bed module array.

18. The optical fiber preform fabricating apparatus as claimed in claim 17, wherein at least one permanent magnet is provided within the guide rib to guide the horizontal reciprocating motion using a repulsive force of the magnet.

19. The optical fiber preform fabricating apparatus as claimed in claim 1, wherein at least one burner is provided below the quartz tubes in a plane perpendicular to the length of the chamber housing.

20. The optical fiber preform fabricating apparatus as claimed in claim 1, wherein the head stock is coupled to the roller mounted on the rails on the inner wall at the upper part of the chamber housing and interlocked with one end of the bed module array whose length can be adjusted by controlling the number of bed modules, and wherein the tail stock is interlocked with the other end of the bed module array and coupled to the roller mounted on the rails so that the rotating chuck of the head stock and the tail chuck of the tail stock can rotatably hold both ends of the quartz tube, and wherein the head stock and tail stock are horizontally movable back and forth in the longitudinal direction with the operation of the driving motor, and when the quartz tube is longer than the bed module array, the tail stock is separated from the bed module array to couple additional bed modules in accordance with the length of the quartz tube and then interlocked again with the bed module array.

21. An optical fiber preform fabricating apparatus for heating a plurality of quartz tubes using at least one burner to deposit chemical reactants on the outer walls of the quartz tubes, comprising:
a chamber housing extending longitudinally; and
a variable-length device mounted within the chamber housing in a longitudinal direction and adjustable in accordance with the length of the quartz tubes, the variable-length device horizontally reciprocating in the longitudinal direction.

22. The optical fiber preform fabricating apparatus as claimed in claim 21, wherein the chamber housing includes gas outlets on top thereof to discharge undeposited soot and chemical reactants entrained in oxygen gas in form of a gaseous mixture.
